(19) United States
(12) Patent Application Publication
(10) Pub. No.: US 2026/0064761 A1
(43) Pub. Date: Mar. 5, 2026

(54) Visual Search Pivot Generation

(71) Applicant: eBay Inc., San Jose, CA (US)

(72) Inventors: Rui Kong, PORTLAND, OR (US); Shubhangi Tandon, Dublin, CA (US); Hongjun Yu, Santa Clara, CA (US)

(73) Assignee: eBay Inc., San Jose, CA (US)

(21) Appl. No.: 18/821,392

(22) Filed: Aug. 30, 2024

(51) Int. Cl. G06F 16/532; G06Q 30/0601; G06V 10/80

(52) U.S. Cl. CPC G06F 16/532; G06Q 30/0627; G06Q 30/0643; G06V 10/811

(57) ABSTRACT

In accordance with techniques for visual search pivot generation, a visual search request is received to trigger a visual search for items that are visually similar to a seed item. Using a machine learning model, one or more pivots representing visual attribute values for refining the visual search are generated based on information associated with the seed item. The one or more pivots are communicated for display in a user interface, and a user selection of a pivot is received. In response, at least one item is communicated for display in the user interface that is visually similar to the seed item and has a visual attribute value corresponding to the pivot.

### BACKGROUND

Visual search techniques involve using images as a query to search for similar or related images on a search platform. Example use cases of visual search techniques include searching for items that are visually similar to an item image on an electronic marketplace and searching for images (e.g., in an image database or as part of a general internet search) that are visually similar to or include an object depicted in a search image. Visual search is a powerful and useful tool that enables searching users to provide additional context with respect to a search query, particularly when words are insufficient to describe a user's search intent.

### SUMMARY

In accordance with the described techniques for visual search pivot generation, a visual search pivot system receives a visual search request to trigger a visual search for items that are visually similar to a seed item. The visual search pivot system employs a machine learning model as part of a process for generating one or more pivots representing visual attribute values for further refining the visual search. The machine learning model receives, as conditioning signals, information associated with the seed item (e.g., images of the seed item, an item title of the seed item, an item category of the seed item), and/or user session data of a user submitting the visual search request, e.g., previous user queries of a current browsing session, items viewed and/or interacted with during a current browsing session, and the like. The visual search pivot system is further configured to communicate the pivots to a client device along with search results including items that are visually similar to the seed item, e.g., for the pivots and the search results to be displayed in a user interface of a search platform. In response to a user selection of a pivot, the visual search pivot system communicates updated search results to the client device including items that are visually similar to the seed item and have a visual characteristic corresponding to the selected pivot, e.g., for the updated search results to be displayed in the user interface of the search platform.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

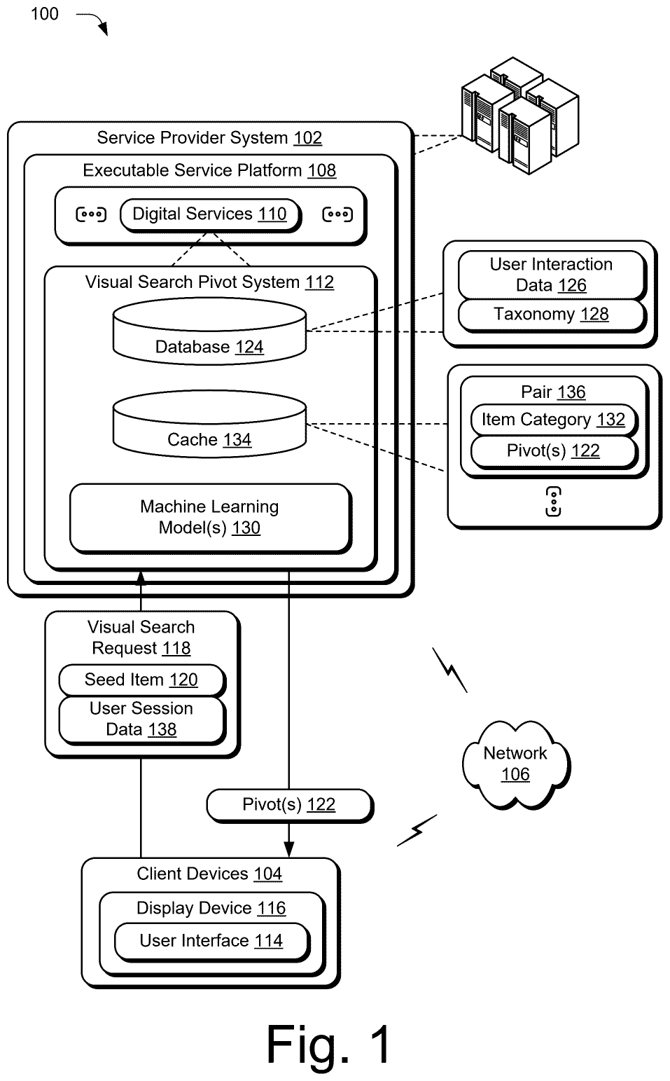

FIG. 1 is an illustration of a digital medium environment in an example implementation that is operable to employ techniques for visual search pivot generation.

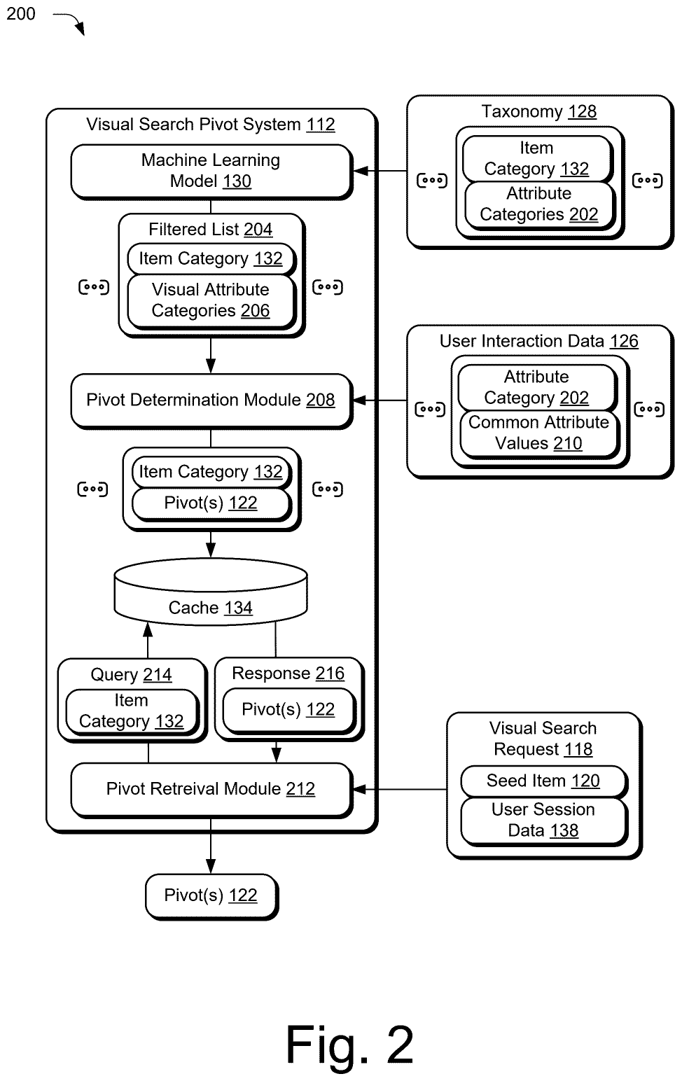

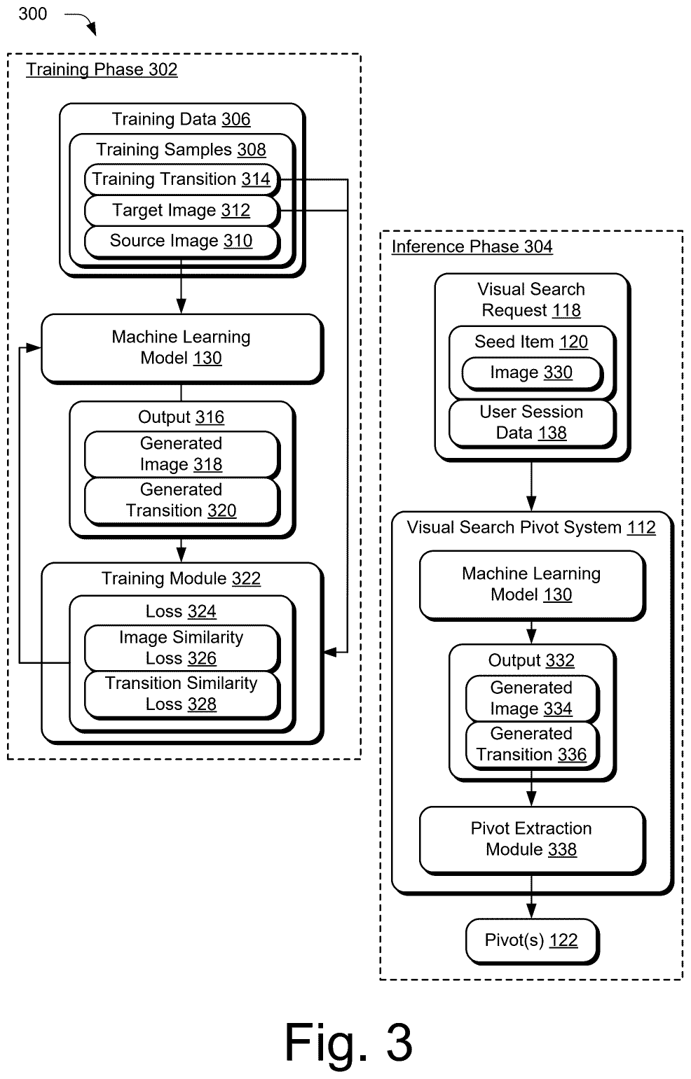

FIG. 2 depicts a system in an example implementation showing operation of a visual search pivot system to generate one or more pivots for a seed item in one or more implementations.

FIG. 3 depicts a system in an example implementation showing operation of a visual search pivot system to generate one or more pivots for a seed item in one or more implementations.

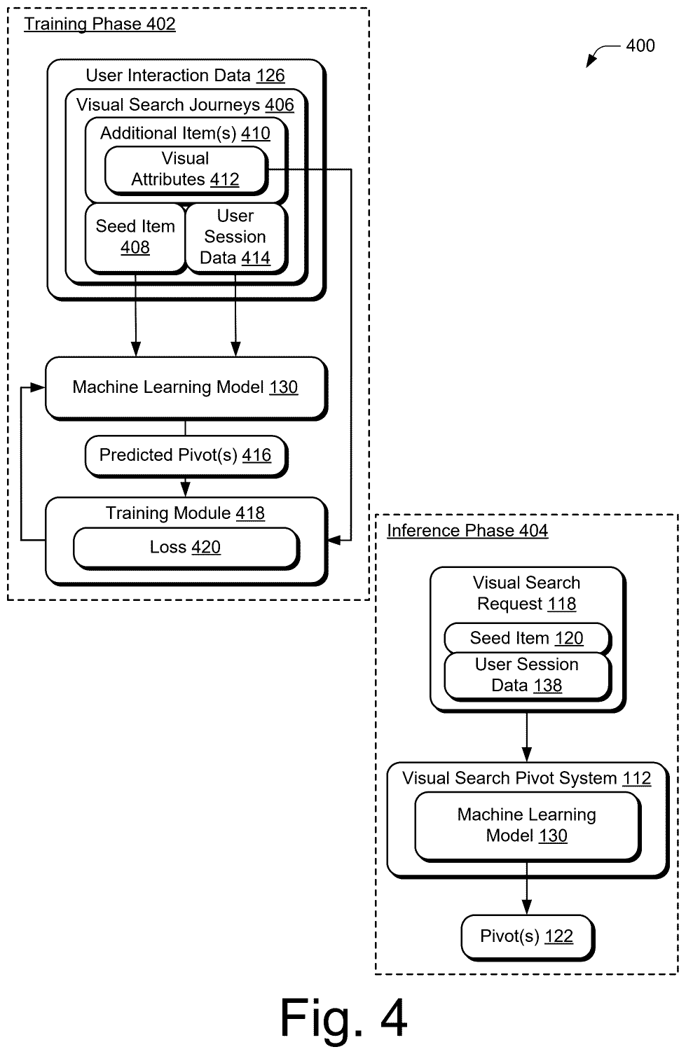

FIG. 4 depicts a system in an example implementation showing operation of a visual search pivot system to generate one or more pivots for a seed item in one or more implementations.

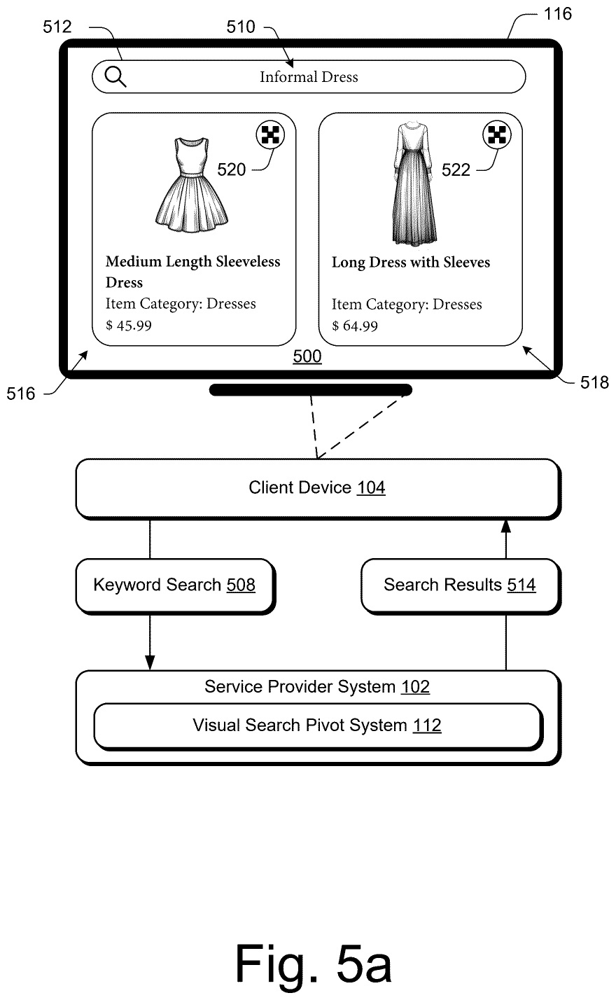

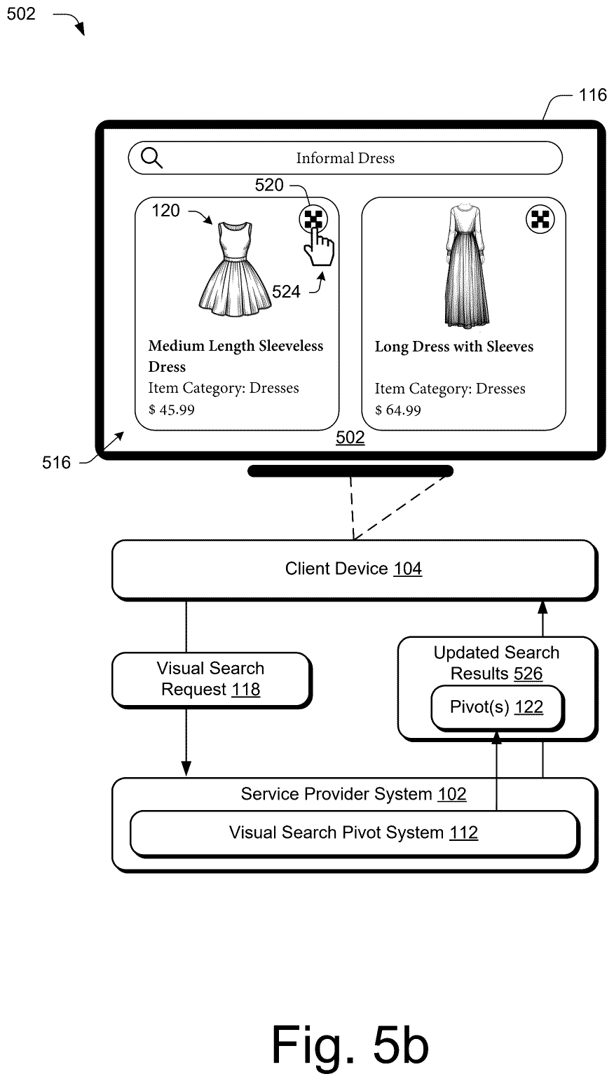

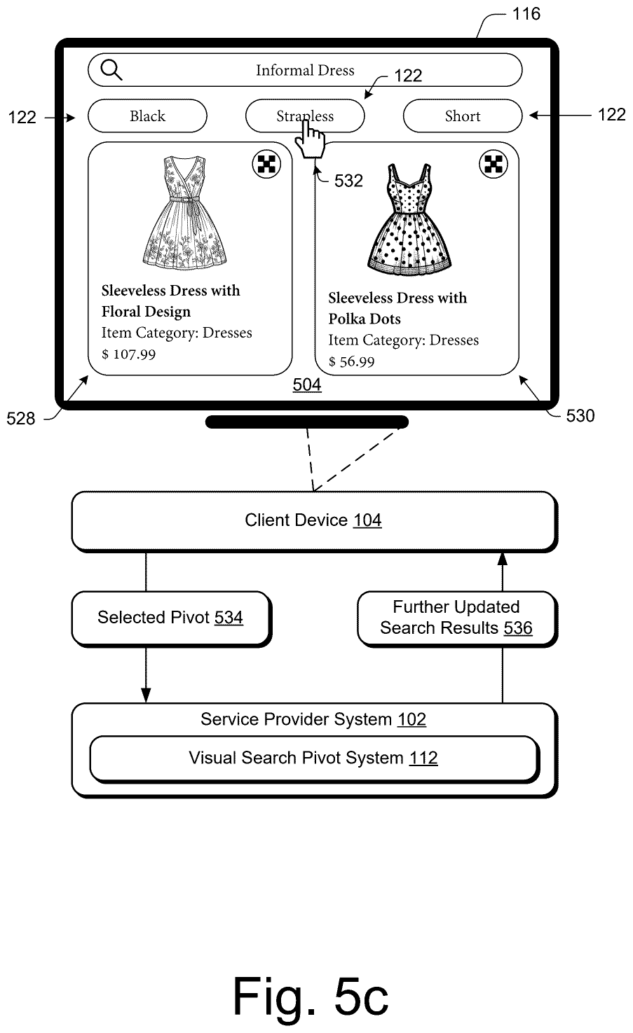

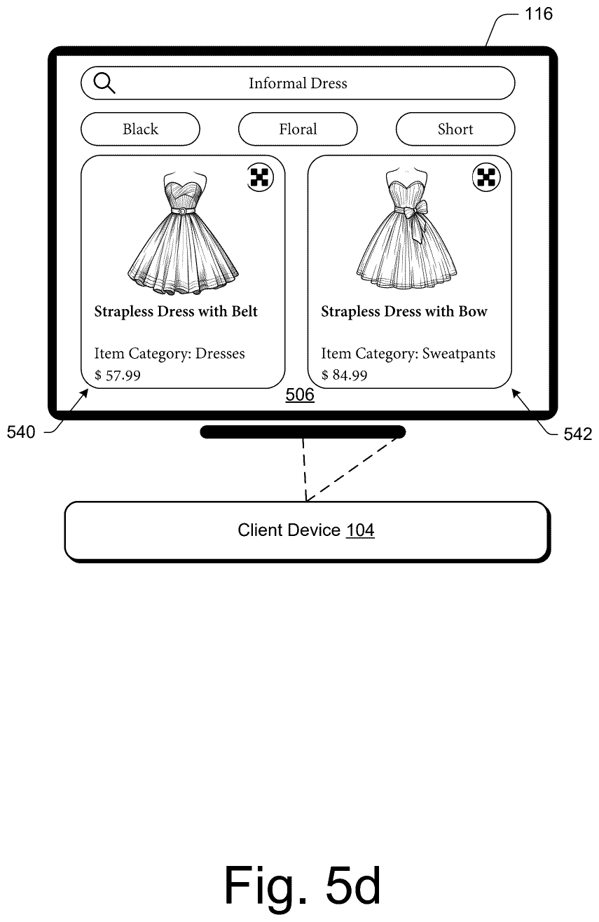

FIG. 5a, FIG. 5b, FIG. 5c, and FIG. 5d depict example user interfaces of a client device as a user interacts with a visual search pivot system of a service provider system.

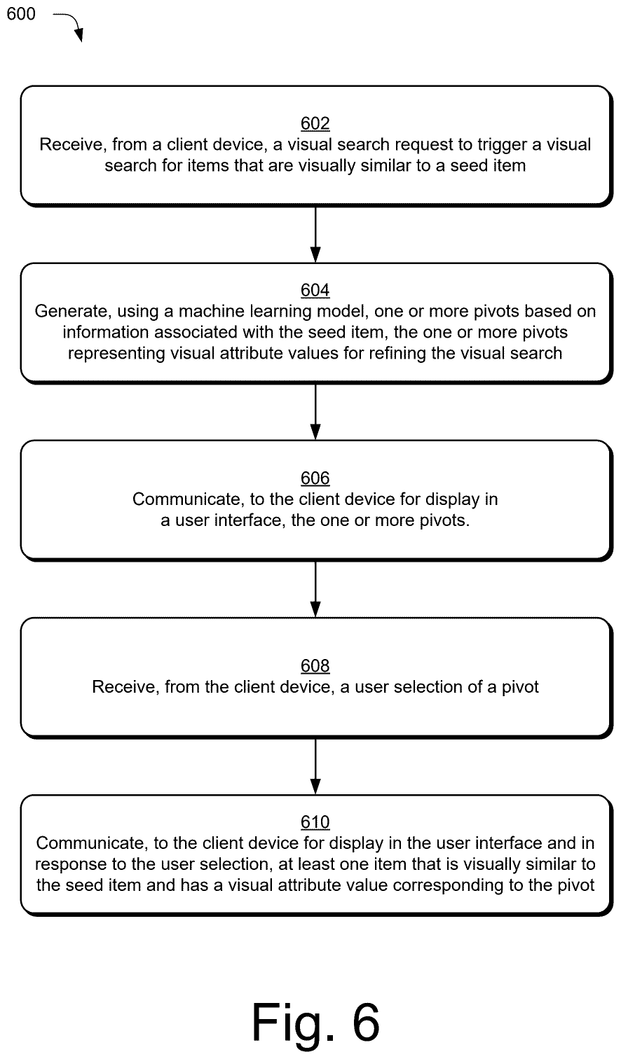

FIG. 6 is a flow diagram depicting a procedure in an example implementation of visual search pivot generation.

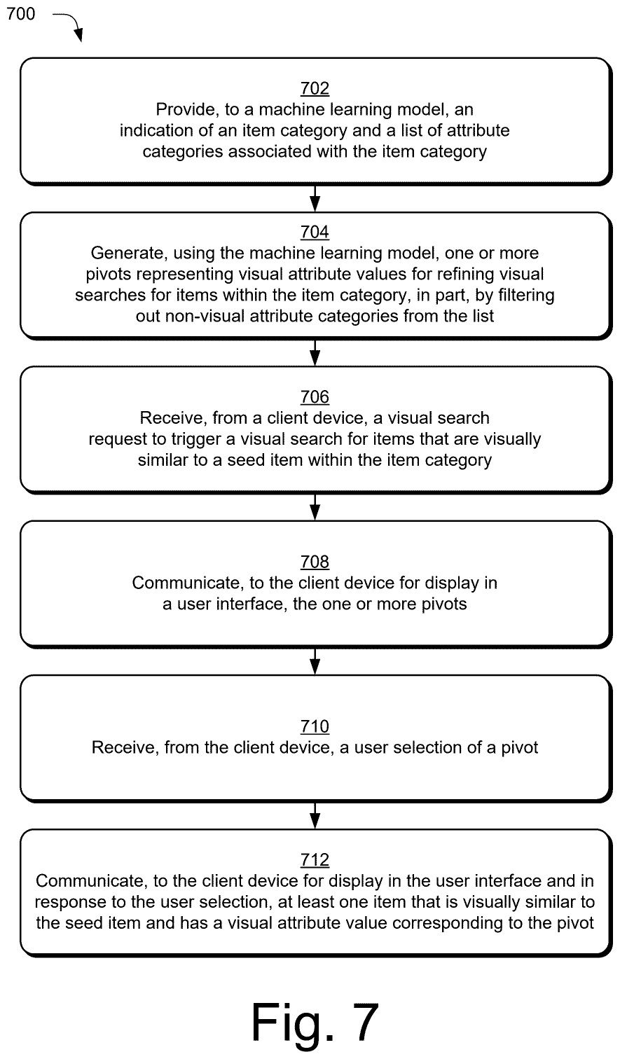

FIG. 7 is a flow diagram depicting a procedure in an example implementation of visual search pivot generation.

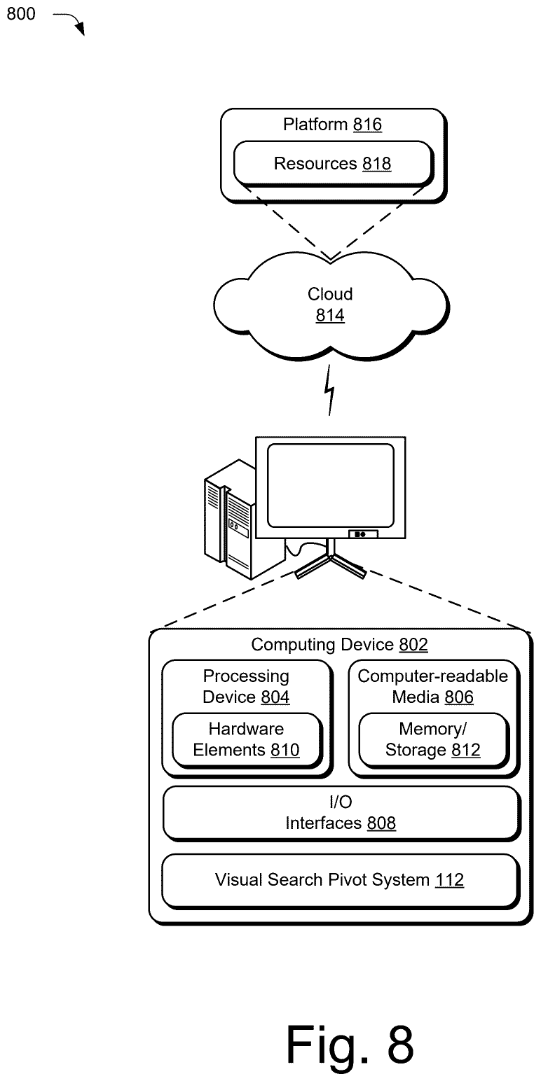

FIG. 8 illustrates an example system including various components of an example device that can be implemented as any type of computing device as described and/or utilized with reference to FIGS. 1-7 to implement embodiments of the techniques described herein.

### DETAILED DESCRIPTION

### Overview

Visual search techniques enable a user to search for content using images as part of a search query rather than, or in addition to, text and/or keywords. In various examples, for instance, a client device is communicatively coupled over a network to a service provider system that exposes a search platform, e.g., an electronic marketplace in which a user of the client device is able to search for items listed via the electronic marketplace. In response to a keyword search submitted by a user of the client device, the service provider system surfaces search results to the client device that correspond to the keyword search. Furthermore, the user initiates a visual search with respect to a seed item from the search results, and the service provider system surfaces updated search results including items that are visually similar to the seed item.

In various examples, the service provider system surfaces pivots alongside the search results and/or updated search results. In this context, pivots are visual attributes that are selectable to further refine search results, e.g., selection of a pivot causes the service provider system to display updated search results including a visual attribute corresponding to the pivot. Conventional pivot techniques, however, fail to generate pivots based on a current search context of a visual search triggered with respect to a seed item. For at least this reason, pivots surfaced by conventional search platforms frequently fail to capture a user's search intent, thereby requiring repeated keyword queries and/or visual searches in order to present search results including items of interest to the searching user. This results in user frustration and increased consumption of computational resources due to increased communication exchanges between the client device and service provider system to present search results that capture the user's search intent.

Accordingly, techniques for visual search pivot generation are described herein as implemented by a visual search pivot system of a service provider system to generate pivots that are relevant to a current search context of a visual search. In accordance with the described techniques, the service provider system presents search results of a keyword search in a user interface. In the context of an electronic marketplace, the search results include item listings of items listed via the electronic marketplace. Each item listing includes a visual search element that is selectable to initiate a visual search with respect to the listed item. Thus, in response to a user selection of a visual search element of an item listing representing a seed item, the service provider system receives a visual search request to present items and/or item listings that are visually similar to the seed item. Broadly, a “seed item” refers to an item via which a user has triggered a visual search, e.g., the seed item is a visual input that serves as the basis for a visual search to find items that are visually similar to the seed item. Furthermore, items that are “visually similar” to the seed item refer to items having one or more visual characteristics that are the same as or similar to the seed item, including but not limited to, size, shape, color, material, texture, pattern, and so on.

The visual search request is provided as input to the visual search pivot system, which is generally configured to generate one or more pivots that are relevant to the seed item and/or a current search context of the visual search. In accordance with the described techniques, the visual search pivot system employs one or more machine learning models in a process for generating the one or more pivots based on information associated with the seed item and/or user session data. The information associated with the seed item includes, but is not limited to including, a title of the seed item obtained from the item listing, an item category of the seed item obtained from the item listing, and one or one or more images of the seed item obtained from the item listing. The user session data describes user interactions of the user submitting the visual search request with the search platform/electronic marketplace in a current browsing session, such as keyword searches previously entered by the user, items and/or item listings viewed and interacted with, and/or clickstream data describing sequences of items and/or item listings viewed and interacted with.

The pivots are generatable in a variety of ways. In a first example pivot generation process, a machine learning model (e.g., a large language model (LLM) pre-trained for a variety of natural language processing (NLP) tasks) receives an indication of an item category (e.g., candles) and one or more attribute categories (e.g., color, size, shape, scent) associated with the item category. As output, the machine learning model generates a filtered list of visual attribute categories (e.g., color, size, shape) associated with the item category by filtering out non-visual attribute categories (e.g., scent) from the list. Furthermore, the visual search pivot system receives user interaction data including a plurality of attribute categories paired with common and/or frequently interacted with attribute values on the electronic marketplace, e.g., the attribute category color is paired with the common attribute values red, blue, and pink. User interaction data is different from user session data because the user interaction data is collected from a plurality of users on the electronic marketplace over a plurality of browsing sessions. Here, the visual search pivot system outputs, as the pivots associated with the item category, the common attribute values (e.g., red, blue, pink) paired with the visual attribute categories (e.g., color) of the filtered list.

In the first example pivot generation process, the above-described process is repeated for a plurality of item categories, resulting in a plurality of item categories paired with corresponding pivots. In one or more implementations, the visual search pivot system pairs item categories and corresponding pivots together in a cache. Thus, in response to the visual search request, the visual search pivot system queries the cache with the item category, and the cache returns the corresponding pivots associated with the item category.

In a second example pivot generation process, a machine learning model receives, as training data, a training sample including a first image of a training seed item, a second image of a training target item, and a first textual description of a first visual transition from the training seed item to the training target item. In one or more implementations, the training sample is representative of user interaction data describing a visual search journey triggered by a user of the electronic marketplace with respect to the training seed item. Furthermore, the visual search journey ended with an objective user interaction with respect to the training target item on the electronic marketplace, e.g., a conversion initiation action, an add to cart action, etc.

Based on the first image, the machine learning model produces a generated image of a predicted item and a second textual description of a second visual transition from the training seed item to the predicted item. Parameters (e.g., internal weights) of the machine learning model are updated based on a first comparison of the second image to the generated image, and a second comparison of the first textual description to the second visual transition. This process is repeated over a plurality of training samples. As such, the machine learning model learns to generate images of target items that are likely to be transitioned to from seed items based on the user interaction data, as well as textual descriptions from the seed items to the target items.

In the second example pivot generation process, the trained machine learning model receives an image of the seed item (e.g., a sleeveless dress) of the visual search request. Furthermore, the trained machine learning model outputs a generated image of a target item (e.g., a dress with long sleeves), as well as a textual description of a visual transition from the seed item to the target item, e.g., “add long sleeves. To generate the one or pivots, the visual search pivot system extracts visual attributes from the textual description, e.g., “long sleeves.”

In a third example pivot generation process, a machine learning model receives, as training data, user interaction data indicative of a visual search journey triggered with respect to a training seed item. The visual search journey includes additional items interacted with during the visual search journey, visual attributes of the additional items interacted with, and user session data of the visual search journey. During a training phase, the machine learning model is employed to generate predicted pivots based on the information associated with the seed item (e.g., images of the seed item, an item title, and/or an item category) and the user session data. Parameters of (e.g., internal weights) the machine learning model are updated based on a comparison of the visual attributes of the additional items interacted with and the predicted pivots. This process is repeated for a plurality of visual search journeys.

During an inference phase, the visual search pivot system receives the visual search request for items that are visually similar to the seed item including the user session data of the user submitting the visual search request. Furthermore, the machine learning model receives as input the information associated with the seed item and the user session data. Based on the input, the machine learning model generates one or more pivots that are relevant to the seed item based on the information associated with the seed item and the user session data.

Once the pivots are generated, the visual search pivot system communicates updated search results to the client device for display in a user interface along with the generated pivots. Here, the updated search results include items and/or item listings that are visually similar to the seed item, and the pivots correspond to visual attributes that are selectable to further refine the visual search. In response to a user selection of a pivot, the service provider system presents, in the user interface of the client device, items and/or item listings that are visually similar to the seed item which have a visual attribute corresponding to the selected pivot.

Thus, the described techniques generate pivots for refining a visual search based on information associated with a seed item via which the visual search was triggered, user session data of a user that triggered the visual search, and user interaction data describing common and/or popular visual attributes of a user population of a search platform. Given this, the techniques described herein display pivots that are more likely to capture a user's search intent than conventional techniques, which display predetermined or supply-based pivots. As a result, search results that capture the user's search intent are presented faster and with fewer user interactions and communication exchanges between the service provider system and the client device, which leads to increased user satisfaction with the visual search process and decreased consumption of computational and/or network resources. Moreover, by pre-populating the cache with pairs of item categories and corresponding pivots, the described techniques reduce search latency because retrieving the pivots from a pre-populated cache is faster than employing the machine learning model to generate the pivots.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Visual Search Pivot Generation Environment

FIG. 1 is an illustration of a digital medium environment 100 in an example implementation that is operable to employ techniques for visual search pivot generation. The illustrated environment 100 includes a service provider system 102, and a plurality of client devices 104 that are communicatively coupled, one to another, via a network 106. Computing devices that implement the service provider system 102 and the client devices 104 are configurable in a variety of ways.

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, a computing device is also representative of a plurality of different devices, such as multiple servers utilized by a business to perform operations “over the cloud” as illustrated for the service provider system 102 and as described in FIG. 8.

The service provider system 102 includes an executable service platform 108. The executable service platform 108 is configured to implement and manage access to digital services 110 “in the cloud” that are accessible by the client devices 104 via the network 106. Thus, the executable service platform 108 provides an underlying infrastructure to manage execution of digital services 110, e.g., through control of underlying computational resources.

The executable service platform 108 supports numerous computational and technical advantages, including an ability of the service provider system 102 to readily scale resources to address wants of an entity associated with the client devices 104. Thus, instead of incurring an expense of purchasing and maintaining proprietary computer equipment for performing certain computational tasks, cloud computing provides the client devices 104 with access to a wide range of hardware and software resources so long as the client has access to the network 106.

Digital services 110 can take a variety of forms. Examples of digital services include social media services, document management services, storage services, media streaming services, content creation services, productivity services, electronic marketplace services, auction services, and so forth. In some instances, the digital services 110 are implemented at least partially by a visual search pivot system 112 that supports functionality for generating pivots for refining visual searches, and updating visual searches based on user-selected pivots.

A visual search, as used herein, is a search process that allows users to search for information using images rather than, or in addition to, text and/or keywords. In one or more examples, for instance, the visual search pivot system 112 is implemented as part of the electronic marketplace services. Given this, the client device 104 submits a search query (e.g., a keyword search) for items listed via an electronic marketplace to the service provider system 102. In response, the service provider system 102 communicates a list of search results to the client device 104 including items listed via the electronic marketplace that correspond to the query, and the client device 104 displays the list of search results in a user interface 114 of a display device 116. In various visual search examples, a user initiates a visual search request 118 with respect to a seed item 120 of the search results, e.g., by interacting with a user interface element associated with the seed item 120 that is selectable to trigger a visual search with respect to the seed item 120. In response, the service provider system 102 updates the list of search results to include new items that are visually similar to the seed item 120. Notably, a seed item 120 refers to an item via which a user has triggered a visual search.

A pivot 122, as described herein, is a visual attribute that further refines a visual search. Continuing with the previous example, when a visual search is triggered on a seed item 120, the service provider system 102 presents pivots 122 in the user interface 114 along with the updated list of search results. In response to a user selection of a pivot 122, the service provider system 102 again updates the list of search results to include new items that are visually similar to the seed item 120, and which have a visual attribute corresponding to the selected pivot 122. Consider an example in which the seed item 120 is a dress having a particular style (e.g., medium length, strapless, etc.) and a user selects a pivot 122 displaying the word “stripes.” In this example, the service provider system 102 updates the search results to include dresses having the particular style, and also having stripes. Although examples of visual search pivot generation are described herein in the context of an electronic marketplace and/or electronic marketplace services, it is to be appreciated that the described techniques are applicable in a variety of search platforms, including general internet search engines, image database search platforms, social media search platforms, domain-specific search platforms such as search functionality of a software application, and so on.

Thus, a user implements a visual search by initiating a keyword search for an item, selecting a seed item 120 from the results of the keyword search, and initiating a visual search for items that are visually similar to the seed item 120. Oftentimes, however, the results of the keyword search are close to the user's search intent but are missing a few intended visual attributes. Thus, initiating a visual search on these results produces visual search results that are also missing the few intended visual attributes. Pivots 122 can be a useful tool to refine the visual search in order to capture the user's searching intent, but conventional pivot generation techniques fail to generate pivots 122 that are specific to the seed item 120 and/or relevant to a current search context. Due to this, pivots 122 generated by current systems frequently fail to include visual attributes intended by the searching user.

To alleviate the drawbacks of conventional techniques, visual search pivot generation techniques are discussed herein to generate pivots that are specific to a seed item 120 and relevant to a current search context. As part of this, the visual search pivot system 112 includes a database 124, e.g., memory of one or more computing devices of the service provider system 102. As shown, the database 124 includes user interaction data 126 describing interactions of users with the electronic marketplace. By way of example, the service provider system 102 receives events describing user interactions with the electronic marketplace from the client devices 104, processes (e.g., filters, aggregates, cleans, organizes) at least some of the events via data stream processing techniques, and stores the raw or processed data in the database 124 as user interaction data 126. Examples of the user interaction data 126 include, but are not limited to, item listing views, item listing interactions (e.g., clicks, hover actions, add to cart actions, conversion initiations), search query data describing terms and phrases entered as part of search queries, search filters and/or pivots 122 used to refine searches, clickstream data describing items and/or item listings commonly clicked or interacted with together as part of visual search journeys and/or browsing sessions, and common and/or popular attributes (e.g., visual and non-visual attributes) associated with particular items, categories of items, and attribute categories.

In addition, the database 124 includes a taxonomy 128, which is a structured classification system used to organize information into hierarchical categories based on characteristics. By way of example, the taxonomy 128 is divided into categories or classes of items and one or more levels of subcategories or subclasses of items. As part of the listing process, an item listed via the electronic marketplace is assigned to one or more categories and/or one or more subcategories of the taxonomy 128. In one or more implementations, an “item category” of an item as discussed herein is a lowest-level category assigned to the item, e.g., a category or subcategory associated with the item for which there are no subcategories thereunder. In an example in which an item is a bedside lamp, the bedside lamp falls under the category “home and garden,” the subcategory “lamps,” and no further subcategory. In this example, the item category for the bedside lamp is “lamps.”

In one or more implementations, each category and subcategory in the taxonomy 128 are associated with a list of attribute categories associated with the category and subcategory. The list of attribute categories associated with an item category, for instance, include categories of visual and/or non-visual attributes that define characteristics of and differentiate between items within the item category. Continuing with the previous example, the item category “lamps” is associated with attribute categories including color, style, type, shape, and finish.

The visual search pivot system 112 is also illustrated as including one or more machine learning models 130. As used herein, the term “machine learning model” refers to a computer representation that is tunable (e.g., trainable) based on inputs to approximate unknown functions. By way of example, the term “machine learning model” includes a model that utilizes algorithms to learn from, and make predictions on, known data by analyzing the known data to learn to generate outputs that reflect patterns and attributes of the known data. According to various implementations, such a machine learning model uses supervised learning, semi-supervised learning, unsupervised learning, reinforcement learning, continuous learning, interactive learning, and/or transfer learning. For example, a machine learning model is capable of including, but is not limited to, clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. By way of example, a machine learning model makes high-level abstractions in data by generating data-driven predictions or decisions from the known input data.

In accordance with the described techniques, the one or more machine learning models 130 are employable by the visual search pivot system 112 to generate one or more pivots 122 that are relevant to a seed item 120 via which a user has triggered a visual search. In one or more examples, the one or more machine learning models 130 include a large language model (LLM) pre-trained to perform a variety of natural language processing (NLP) tasks. In one or more implementations, the LLM is capable of handling and processing multi-modal inputs (e.g., inputs that include both image data and textual data). Examples of the LLM include, but are not limited to, generative pre-trained transformer (GPT) models, LLAMA models, and contrastive language-image pre-training (CLIP) models. In one or more examples, the LLM is fine-tuned and/or refined using additional training data for a task or subtask of generating pivots 122 that are relevant to a seed item 120. Additionally or alternatively, the one or more machine learning models 130 include a domain-specific model that is specifically trained for a task or subtask of generating pivots 122 that are relevant to a seed item 120.

The one or more machine learning models 130 are employable for pivot generation in a variety of ways. As further discussed below with reference to FIG. 2, for instance, the machine learning model 130 is configured to filter out non-visual attribute categories from the taxonomy 128, and the visual search pivot system 112 generates, for each item category, one or more pivots 122 representing common attribute values within visual attribute categories of the filtered taxonomy based on the user interaction data 126. As further discussed below with reference to FIG. 3, the machine learning model 130 is trained or refined to generate an image of an item that is predicted to be transitioned to from a seed item 120 as part of a visual search journey and generate textual descriptions of visual transitions from the seed item 120 to the predicted item so that pivots 122 can be extracted from the visual transitions. As further discussed below with reference to FIG. 4, the machine learning model 130 is trained or refined to generate, as pivots 122 that are relevant to a seed item 120, the visual attributes of items that are likely to be selected together with the seed item as part of a visual search journey.

In one or more implementations, the visual search pivot system 112 is configured to store one or more pivots 122 associated with each item category 132 in a cache 134, e.g., cache memory of one or more computing devices of the visual search pivot system 112. For instance, the visual search pivot system 112 employs the machine learning model 130 as part of a process for generating one or more pivots 122 that are relevant to items within an item category 132, and the visual search pivot system 112 pairs the item category 132 with the one or more pivots 122 in the cache 134. This process is repeated for a plurality of different item categories 132, resulting in a plurality of pairs 136 each including an item category 132 paired with one or more pivots 122 that are relevant to items within the item category 132. In at least one example, the cache 134 stores a set of key-value pairs in which the item categories 132 are the keys and the corresponding pivot(s) 122 are the values. Although examples are described and depicted herein in which the item categories 132 are paired with the pivot(s) 122, it is to be appreciated that the pivot(s) 122 are assignable to item titles of individual items (rather than item categories 132), and the item titles are pairable with corresponding pivot(s) 122 in the cache 134 in variations.

In accordance with the described techniques, a client device 104 submits a visual search request 118 with respect to a seed item 120 to the service provider system 102. The visual search request 118 includes information associated with the seed item 120, such as an item category 132 to which the seed item 120 belongs, an item title or item identifier of the seed item 120, and/or information extracted from an item listing of the seed item 120, e.g., one or more images of the item listing of the seed item 120, an item description of the item listing, sentiments expressed in comments and/or reviews of the item listing, tags describing characteristics of the item listed via the item listing, and so on. In various examples, for instance, the information associated with the seed item 120 includes visual attributes of the seed item 120 and/or visual attributes of an item category 132 to which the seed item 120 belongs as extracted from the item listing of the seed item 120.

As shown, the visual search request 118 additionally includes user session data 138 in one or more implementations. In the context of a visual search request 118 submitted by a user of a client device 104, for instance, the user session data 138 includes user interaction data of the user during a current browsing session. In the context of electronic marketplace services, a browsing session is a continuous period of interaction between the user and a website or application of the electronic marketplace that begins when the website or application is accessed or opened, and ends when the website or application is closed or the user logs out.

Given this, the user session data 138 includes previous user queries entered by the user during a current browsing session, item listing views by the user during a current browsing session, item listing interactions (e.g., clicks, hover actions, add to cart actions, conversion actions, and the like) during the current browsing session, and clickstream data defining sequences of item listings interacted with in a current browsing session of the user. Additionally or alternatively, the user session data 138 includes contextual information of the visual search request 118, such as a geographical location of the client device 104 submitting the visual search request 118, temporal information of the visual search request 118 (e.g., time of day or season when the visual request 118 is submitted), and/or a device type of the client device 104 submitting the visual search request 118, e.g., smartphone, desktop computer, laptop computer, gaming computer, etc. The user session data 138 differs from the user interaction data 126 in that the user session data 138 is particular to the user and/or client device 104 submitting the visual search request 118, while the user interaction data 126 is collected and/or summarized with respect to a collection of users of the electronic marketplace.

In one or more implementations, the machine learning model 130 is employed as part of a process for generating one or more pivots 122 that are relevant to the seed item 120 based on the information associated with the seed item 120 and/or the user session data 138. In at least one example, the machine learning model 130 is employed as part of generating the one or more pivots 122 relevant to the seed item 120 in response to receiving the visual search request 118. Additionally or alternatively, the machine learning model 130 is employed as part of a process for generating, for each item category 132 of a plurality of item categories 132, pivots 122 that are relevant to seed items within the item category 132 before the visual search request 118 is received. As part of this, the visual search pivot system 112 pre-populates the cache 134 with the pairs 136 of item categories 132 and corresponding pivots 122, as previously discussed. Given this, the visual search pivot system 112 generates the one or more pivots 122 by querying the cache 134 with the item category 132 of the seed item 120 (e.g., the key of the key-value pair), and receiving from the cache 134 the one or more pivots 122 paired with the item category 132, e.g., the value of the key-value pair.

Caching the pairs 136 in the manner described reduces search latency, e.g., the time it takes to present the search results of the visual search request 118 and the pivots 122 in the user interface 114. This is because computational processes to determine the pivots 122 for the respective item categories 132 occurs off the critical search path. In other words, the visual search pivot system 112 and/or the machine learning model 130 perform the computational processes to determine the pivots 122 before receiving the visual search request 118, and as such, avoid these computational processes when processing the visual search request 118. Accordingly, retrieving pivots 122 from the cache 134 is faster than generating the pivots 122 using the machine learning model 130.

In one or more implementations, the service provider system 102 communicates the pivots 122 generated or retrieved for the seed item 120 as well as the search results including items (e.g., item listings) that are visually similar to the seed item 120 to the client device 104. In response, the client device 104 displays the search results and the pivots 122 in the user interface 114. In various scenarios, the service provider system 102 receives a user selection of a pivot 122, and in response, the service provider system 102 communicates updated search results to the client device 104 including items (e.g., item listings) that are visually similar to the seed item 120 and have a visual characteristic corresponding to the pivot 122.

Accordingly, the described techniques generate pivots 122 for refining a visual search using machine learning based on information associated with a seed item 120 via which the visual search was triggered, user session data 138 of the user that triggered the visual search, and/or user interaction data 126 describing common and/or popular visual attributes within an electronic marketplace. Given this, the techniques described herein display pivots 122 that are more likely to capture a user's search intent than conventional techniques.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Visual Search Pivot Generation Features

FIG. 2 depicts a system 200 in an example implementation showing operation of a visual search pivot system to generate one or more pivots for a seed item in one or more implementations. As shown, the machine learning model 130 receives the taxonomy 128 e.g., from the database 124. As previously mentioned, the taxonomy 128 is divided into categories and subcategories, and an item category 132 of an item is a lowest-level category or subcategory of the item. In other words, the taxonomy 128 includes a plurality of item categories 132 (e.g., including categories and subcategories of the taxonomy 128) to which the items can possibly be assigned. Moreover, each item category 132 is paired with a list of attribute categories 202 associated with items within the item category 132. Attributes within the attribute categories 202 of an item category 132, for instance, serve to define characteristics of and differentiate between items in the item category 132.

Although not depicted, the machine learning model 130 additionally receives a prompt in one or more implementations, and the prompt requests the machine learning model 130 to filter out non-visual attributes from the taxonomy 128. In one or more implementations, the machine learning model 130 of the system 200 is an LLM that has been pre-trained to perform a variety of NLP tasks, including prompt/question answering, e.g., a GPT model. The LLM can be employed in an “off-the-shelf” manner, or the LLM can be refined and/or fine-tuned for the task of filtering out non-visual attribute categories from a list of attribute categories. Additionally or alternatively, the machine learning model 130 of the system 200 is a domain-specific model trained specifically for the task of filtering out non-visual attribute categories from a list of attribute categories.

In one or more implementations, the training dataset used to train and/or refine the machine learning model 130 includes a plurality of attribute categories each paired with a label indicating whether the attribute category is visual or non-visual. During training, the machine learning model 130 is employed to classify an attribute of the training dataset as visual or non-visual. Furthermore, parameters (e.g., internal weights) of the machine learning model 130 are updated based on whether the predicted classification matches the ground truth classification of the label paired with the attribute. This process is repeated iteratively for different attributes of the training dataset until model convergence or a threshold number of epochs have been processed.

Thus, in various implementations, the machine learning model 130 receives an item category 132 and a list of attribute categories 202 paired therewith. As output, the machine learning model 130 generates a filtered list 204 of visual attribute categories 206 by filtering out non-visual attribute categories from the list attribute categories 202. Consider an example in which the attribute categories 202 for an item category 132 include shape, size, color, and scent. In this example, the filtered list 204 for the item category 132 includes shape, size, and color as visual attribute categories 206, and excludes scent as a non-visual attribute category. This process is repeated for each item category 132 of the taxonomy 128, resulting in a filtered list 204 of visual attribute categories 206 for each item category 132 of the taxonomy 128.

In one or more implementations, the machine learning model 130 is configured to perform multiple rounds of filtering operations. For example, in a first round of filtering, the machine learning model 130 receives the taxonomy 128 and the prompt as input. During the first round of filtering, the machine learning model 130 generates, for each respective item category 132, a first filtered list by filtering out non-visual attribute categories from the attribute categories 202 paired with the respective item category 132. In a second round of filtering, the machine learning model 130 receives the first filtered lists and the prompt as input. During the second round of filtering, the machine learning model 130 generates, for each respective item category 132, a second filtered list by filtering out non-visual attribute categories from the first filtered list. Any number of filtering rounds are performable by the machine learning model 130 in variations. By performing multiple rounds of filtering operations, the machine learning model 130 filters out non-visual attribute categories that were incorrectly classified as visual attribute categories during earlier filtering rounds.

As shown, the filtered lists 204 are provided as input to a pivot determination module 208. In addition, the pivot determination module 208 receives user interaction data 126 (e.g., from the database 124), and the user interaction data 126 includes a plurality of attribute categories 202 paired with common attribute values 210. Notably, attribute categories 202 differ from attribute values 210 in that attribute values 210 define attributes within the attribute categories 202. For example, the user interaction data 126 includes color as an attribute category 202, and the common attribute values 210 paired therewith include red, blue, and green.

Here, the common attribute values 210 are “common” in the sense that item listings having the attribute values are frequently interacted with. For example, item listings exhibiting the common attribute values 210 are interacted with (e.g., clicked, added to cart, entered as part of searches, used to refine searches, and so on) more than other attribute values within the attribute category. In at least one example, the common attribute values 210 represent a top percentile (e.g., the top ten percent) of attribute values most frequently interacted with for the attribute category 202. In one or more implementations, the visual search pivot system 112 employs data stream processing techniques for processing events describing user interactions with item listings to identify the common attribute values 210 associated with an attribute category 202, as previously mentioned. In various scenarios, the visual search pivot system 112 continuously, and in near real-time, updates the common attribute values 210 associated with an attribute category 202 based on newly received events describing interactions with item listings.

In one or more examples, the common attribute values 210 associated with an attribute category 202 are common or frequently interacted with across all item listings on the electronic marketplace. For instance, the user interaction data 126 includes an attribute category 202, and the common attribute values 210 paired therewith are common or popular across a plurality of item categories 132. Additionally or alternatively, the common attribute values 210 are specific to an item category 132. For instance, the user interaction data 126 includes color as an attribute category 202 for multiple item categories 132. Given this, the user interaction data 126 includes, for each item category 132 of the multiple item categories 132, a different set of common attribute values 210 within the color attribute category 202. For example, the common attribute values 210 of the color attribute category 202 include blue, brown, and black for the pants item category 132, but the common attribute values 210 of the color attribute category 202 include white, black, and grey for the shoes item category 132.

Given a filtered list 204 associated with an item category 132, the pivot determination module 208 extracts the common attribute values 210 that are paired with the visual attribute categories 206 of the filtered list 204 in the user interaction data 126. Furthermore, the extracted common attribute values 210 include or correspond to the pivots 122 associated with the item category 132. Consider an example in which the filtered list 204 of the pants item category 132 includes the visual attribute categories 206 color and fit. In this example, the color attribute category 202 is paired with common attribute values 210 brown, blue, and black, while the fit attribute category 202 is paired with common attribute values 210 straight, slim, and athletic. Given the above, the pivot determination module 208 extracts, as the pivots 122 associated with the pants item category 132, brown, blue, black, straight, slim, and athletic. This process is repeated for each item category 132. As a result, the pivot determination module 208 outputs a plurality of item categories 132, each paired with one or more pivots 122 representing visual attributes for further refining a visual search for items within a respective item category 132.

More specifically, the pivot determination module 208 outputs the item categories 132 paired with the corresponding pivot(s) 122 to the cache 134. Given an item category 132 paired with one or more pivots 122, for instance, the cache 134 includes the item category 132 as a key of a key-value pair, and the one or more pivots 122 as a value of the key-value pair. After the item categories 132 paired with the corresponding pivot(s) 122 are cached, a pivot retrieval module 212 receives the visual search request 118 from a client device 104 for items that are visually similar to the seed item 120. As previously mentioned, the visual search request 118 includes information associated with the seed item 120, such as the item category 132 of the seed item 120. Given this, the pivot retrieval module 212 submits a query 214 to the cache 134 in response to receiving the visual search request 118, and the query 214 includes the item category 132 of the seed item 120. In response, the cache 134 returns a response 216 including the pivots 122 paired with the item category 132 in the cache 134, as shown. In one or more implementations, the retrieved pivots 122 are communicated to the client device 104 for display in a user interface 114.

Additionally or alternatively, the visual search pivot system 112 is configured to select one or more pivots 122 from the pivots 122 retrieved from the cache 134 based on the user session data 138. For example, the user session data 138 includes item listings viewed by the user in a current browsing session, item listings interacted with during a current browsing session, and previous user queries entered by the user during a current browsing session. Accordingly, the visual search pivot system 112, selects a predetermined number of (e.g., three) pivots 122 from the retrieved pivots 122 for presentation in the user interface 114 of the client device 104. Furthermore, the selected pivots 122 are similar to or associated with the previously entered user queries and the item listings previously viewed or interacted with as indicated by the user session data 138.

To do so in one or more implementations, the visual search pivot system 112 encodes the user session data 138 (e.g., including images of item listings viewed and/or interacted with, text-based information extracted from the item listings viewed and/or interacted with, and terms and/or phrases entered as part of the previous user queries) and the retrieved pivots 122 as vectors in a common multi-modal embedding space. To so, the visual search pivot system 112 uses an LLM that is capable of processing multi-modal inputs, such as a LLAMA model or a CLIP model. Furthermore, the visual search pivot system 112 selects, as the pivots 122 to present in the user interface 114 of the client device 104, a predefined number (e.g., three) of the retrieved pivots 122 having representative vectors with a shortest distance (e.g., Euclidean distance) to the vector representing the user session data 138. As further discussed below with reference to FIGS. 5a-5d, the visual search pivot system 112 presents in the user interface 114 of the client device 104 search results including a plurality of item listings depicting items that are visually similar to the seed item 120, as well as the retrieved and/or selected pivots 122.

FIG. 3 depicts a system 300 in an example implementation showing operation of a visual search pivot system to generate one or more pivots for a seed item in one or more implementations. In particular, the system 300 includes a training phase 302 showing how the machine learning model 130 is trained to generate an image of an item that is predicted to be transitioned to from a seed item 120 as part of a visual search journey, and textual descriptions of visual transitions from the seed item 120 to the predicted item. In addition, the system 300 includes an inference phase 304 showing how the machine learning model 130 is employed by the visual search pivot system 112 to generate one or more pivots 122 that are relevant to a seed item 120 in response to a visual search request 118.

In one or more implementations, the machine learning model 130 of the system 300 is an LLM that is capable of handling and processing multi-modal inputs, such as a LLAMA model and/or a CLIP model. As discussed below, the LLM is refined or fine-tuned using training data 306. Additionally or alternatively, the machine learning model 130 of the system 300 is a domain-specific model that is specifically trained using the training data 306. The training data 306 includes a plurality of training samples 308. Further, each of the training samples 308 includes a source image 310 of a training seed item, a target image 312 of a training target item, and a training transition 314 that includes a textual description of a visual transition from the training seed item to the training target item. In one or more implementations, the training seed item and the training target item correspond to user interaction data 126 representing items that are selected together as part of a visual search journey that resulted in an objective of the electronic marketplace, e.g., an add to cart objective, a conversion initiation, and the like. For example, a visual search journey by a user is initiated with a visual search request 118 with respect to a listing of a training seed item (e.g., including the source image 310), and ended with an add to cart action with respect to a listing of a training target item, e.g., including the target image 312.

In one or more implementations, the training transition 314 is generated using an additional machine learning model. In examples in which the machine learning model 130 is the domain-specific model, for instance, the additional machine learning model is an LLM that is pre-trained to perform a variety of NLP tasks, and is capable of handling and processing multi-modal inputs, such as a GPT-4 model. Given this, the additional machine learning model receives the source image, the target image, and a prompt requesting the LLM to generate a textual description of a visual transition from the source image 310 to the target image 312. As output, the additional machine learning model generates the training transition 314. Additionally or alternatively, the training transition 314 is generated by human annotators describing the visual transition from the seed item of the source image 310 to the target item of the target image 312.

Given a source image 310 of a training sample 308 as input, the machine learning model 130 produces an output 316 that includes a generated image 318 and a generated transition 320. Here, the generated image 318 depicts a predicted item that the machine learning model 130 predicts to be transitioned to from the source image 310 as part of a visual search journey. In addition, the generated transition 320 is a textual description of a visual transition from the training seed item to the predicted item. As shown, the output 316 is provided to a training module 322, along with the target image 312 and the training transition 314. Generally, the training module 322 is configured to update the machine learning model 130 based on a first comparison of the generated image 318 and the target image 312, and a second comparison of the generated transition 320 to the training transition 314.

To do so, the training module 322 computes a loss 324, e.g., using a loss function. The loss 324 includes two loss terms—an image similarity loss 326 capturing a degree of difference between the generated image 318 and the target image 312, and a transition similarity loss 328 capturing a degree of difference between the generated transition 320 and the training transition 314. To determine the image similarity loss 326, the training module 322 generates a first vector representing the generated image 318 and a second vector representing the target image 312 (e.g., using an image vectorization technique, such as a VGGNet model), and computing a distance (e.g., using a distance function, such as Euclidean distance) between the first vector and the second vector. To determine the transition similarity loss 328, the training module 322 generates a first vector representing the generated transition 320 and a second vector representing the training transition 314 (e.g., using a word and/or sentence vectorization technique, such as a Word2Vec model and/or a universal sentence encoder (USE) model), and computing a distance (e.g., using a distance function, such as Euclidean distance) between the first vector and the second vector. The training module 322 is configured to update parameters (e.g., internal weights) of the machine learning model 130 to reduce the loss 324. This process is repeated iteratively on different training samples 308 until the loss converges to a minimum, a threshold number of training samples 308 have been processed, or a threshold number of epochs have been processed.

Although not shown in the illustrated example, the training samples 308 include training session data in one or more implementations. As previously mentioned, a training sample 308 includes the source image 310 of the training seed item and the target image 312 of the training target item, which are selected together as part of a visual search journey. Given this, the training session data of the training sample 308 includes user session data 138 of the browsing session that resulted in the visual search journey. The training session data is used as one or more additional conditioning signals for the machine learning model 130 in producing the generated image 318. In this way, the machine learning model 130 learns to produce generated images 318 and generated transitions 320 based, in part, on user session data 138.

During the inference phase 304, the visual search pivot system 112 receives a visual search request 118 to present search results including items and/or item listings that are visually similar to a seed item 120. Here, the visual search request 118 includes an image 330 of the seed item 120. Additionally or alternatively, the visual search request 118 includes the user session data 138 of a browsing session of the user submitting the visual search request 118. In one or more implementations, the image 330 and/or the user session data 138 are provided as input to the trained machine learning model 130.

Based on the image 330 of the seed item 120 and/or the user session data 138, the machine learning model 130 produces an output 332 including a generated image 334 and a generated transition 336. As part of this, the machine learning model 130 predicts an item to be transitioned to from the seed item 120, and produces a generated image 334 depicting the predicted item. Furthermore, the machine learning model 130 produces a generated transition 336 including a textual description of a visual transition from the seed item 120 to the predicted item. Consider an example in which the seed item 120 is a red dress having no sleeves, and the generated image 334 depicts a blue dress having long sleeves. In this example, the generated transition 336 includes the phrases “add long sleeves” and “change color to blue.”

As shown, the generated transition 336 is provided as input to a pivot extraction module 338, which is configured to extract, as the pivots 122 associated with the seed item 120, visual attributes from the generated transition 336. In one or more examples, the pivot extraction module 338 uses rules-based NLP techniques to extract visual attributes from the generated transition 336, including but not limited to part-of-speech (POS) tagging, and named entity recognition (NER). Additionally or alternatively, the pivot extraction module 338 includes or corresponds to an LLM that is pre-trained to perform a variety of NLP processing tasks including question/prompt answering, e.g., a GPT model. Given this, the generated transition 336 is provided as input to the LLM along with a prompt requesting that the LLM extract visual attributes from the generated transition 336. Further, the LLM outputs, as the pivots 122 associated with the seed item 120, visual attributes included in the generated transition 336. Returning to the previous example in which the generated transition 336 includes the phrases “add long sleeves” and “change color to blue,” the pivot extraction module 338 extracts, as the pivots 122 associated with the seed item 120, the visual attributes “long sleeves” and “blue.” As further discussed below with reference to FIGS. 5a-5d, the visual search pivot system 112 presents in the user interface 114 of the client device 104 search results including a plurality of item listings depicting items that are visually similar to the seed item 120, as well as the extracted pivots 122.

Although the system 300 is described and depicted as prompting the machine learning model 130 to produce the output 332 in response to the visual search request 118 in the inference phase 304, these examples are not to be construed as limiting. Rather, it is to be appreciated that the visual search pivot system 112 pairs item titles of a plurality of items with corresponding pivots 122 in the cache 134 in one or more implementations. By way of example, the visual search pivot system 112 receives a plurality of items and images thereof, and the visual search pivot system 112 employs the machine learning model to produce an output 332 for each of the items. Furthermore, the pivot extraction module 338 extracts one or more pivots 122 from the generated transition 336 for each of the items, and pairs item titles of the items with the corresponding pivots 122 in the cache 134. Thus, when a visual search request 118 is received, the visual search pivot system 112 queries the cache with an item title of the seed item 120, and retrieves the corresponding pivots 122.

FIG. 4 depicts a system 400 in an example implementation showing operation of a visual search pivot system to generate one or more pivots for a seed item in one or more implementations. In particular, the system 400 includes a training phase 402 showing how the machine learning model 130 is trained to generate one or more pivots that are relevant to a seed item 120. In addition, the system 400 includes an inference phase 404 showing how the machine learning model 130 is employed by the visual search pivot system 112 to generate one or more pivots 122 that are relevant to a seed item 120 in response to a visual search request 118. In one or more implementations, the machine learning model 130 of the system 400 is a domain-specific model trained specifically for the task of generating one or more pivots 122 that are relevant to a seed item 120.

During the training phase, the machine learning model 130 receives, as training data, user interaction data 126 from the database 124. Here, the user interaction data 126 includes visual search journeys 406. By way of example, a visual search journey 406 begins when a user submits a visual search request 118 for items that are visually similar to a seed item 120, and ends when the user terminates the visual search, e.g., by initiating a new keyword search, closing a website or application via which the visual search was triggered, or triggering a visual search for items that are visually similar to a new seed item 120. Each respective visual search journey 406 includes a seed item 408 via which the visual search of the respective visual search journey 406 was triggered. In addition, each respective visual search journey 406 includes one or more additional items 410 that were interacted with (e.g., clicked, viewed, added to cart, etc.) as part of the visual search journey 406.

As shown, the additional items 410 include visual attributes 412. Given an additional item 410 of an item listing, for instance, the visual attributes 412 of the additional item 410 are depicted in one or more images obtained from the item listing and/or the visual attributes 412 are obtained from textual data of the item listing, e.g., an item title, an item description, item tags (e.g., labels or keywords) that categorize and describe the item, and so on. To identify the visual attributes 412 of the additional item 410 in one or more implementations, the visual search pivot system 112 employs an LLM that is pre-trained to perform a variety of NLP tasks, and is capable of handling and processing multi-modal inputs, such as a GPT-4 model. Further, the visual search pivot system 112 provides the LLM with one or more images of the additional item 410 obtained from an item listing, the textual data of the item listing, and a prompt requesting the LLM to extract keywords describing visual attributes 412 of the additional item 410 from the one or more images and the textual data of the item listing. The keywords extracted by the LLM are the visual attributes 412 of the additional item 410.

In one or more implementations, the visual search journeys 406 additionally include user session data 414. Given a visual search journey 406, for instance, the user session data 414 describes user interactions of a user during a current browsing session before the user initiated the visual search journey 406. Such user interactions include previous user queries entered by the user, item listings previously viewed, item listings previously interacted with, and so on. In accordance with the described techniques, information associated with the seed item 408 (e.g., a title of the seed item 408, an item category 132 of the seed item 408, and one or more images from an item listing of the seed item 408) is provided as input to the machine learning model 130 along with the user session data 414. Based on the information associated with the seed item 408 and/or the user session data 414, the machine learning model 130 generates predicted pivots 416 representing visual attributes for refining a visual search triggered on the seed item 408.

As shown, the one or more predicted pivots 416 are provided as input to a training module 418 along with the visual attributes 412 of the additional items 410. Generally, the training module 418 is configured to train the machine learning model 130 to generate pivots that are relevant to a seed item by comparing the visual attributes 412 and the predicted pivots 416. As part of this, the training module 418 generates a loss 420 based on a degree of difference between the predicted pivots 416 and the visual attributes 412. To do so, in one or more implementations, the training module 418 generates one or more first vectors representing the predicted pivots 416 and one or more second vectors representing the visual attributes 412, e.g., using a word vectorization technique, such as a Word2Vec model. Furthermore, the training module 418 determines the loss 420 by computing a distance (e.g., using a distance function, such as Euclidean distance) between the one or more first vectors and the one or more second vectors. The training module 418 is configured to update parameters (e.g., internal weights) of the machine learning model 130 to reduce the loss 420. This process is repeated iteratively on different visual search journeys 406 until the loss converges to a minimum, a threshold number of visual search journeys 406 have been processed, or a threshold number of epochs have been processed.

During the inference phase 404, the visual search pivot system 112 receives the visual search request 118 to present search results including items and/or item listings that are visually similar to a seed item 120. Here, the visual search request 118 includes the information associated with the seed item 120 (e.g., an item title of the seed item, an item category 132 of the seed item 120, one or more images obtained from an item listing of the seed item 120), as well as the user session data 138 of the user submitting the visual search request 118. Based on the information associated with the seed item 120 and the user session data 138, the machine learning model 130 generates one or more pivots 122. As further discussed below with reference to FIGS. 5a-5d, the visual search pivot system 112 presents in the user interface 114 of the client device 104 search results including a plurality of item listings depicting items that are visually similar to the seed item 120, as well as the generated pivots 122.

Although the system 400 is described and depicted as prompting the machine learning model 130 to generate pivots 122 in response to the visual search request 118 in the inference phase 404, these examples are not to be construed as limiting. Rather, it is to be appreciated that the visual search pivot system 112 pairs item titles of a plurality of items with corresponding pivots 122 in the cache 134 in one or more implementations. By way of example, the visual search pivot system 112 receives a plurality of items and information associated with the items, and the visual search pivot system 112 employs the machine learning model to generate pivots for each of the items based on the information associated with the item. Furthermore, the visual search pivot system 112 pairs item titles of the items with the corresponding pivots 122 in the cache 134. Thus, when a visual search request 118 is received, the visual search pivot system 112 queries the cache with an item title of the seed item 120, and retrieves the corresponding pivots 122.

FIGS. 5a-5d depict example user interfaces 500, 502, 504, 506 of a client device as a user interacts with a visual search pivot system of a service provider system. In FIG. 5a, a user of the client device 104 submits a keyword search 508 to the service provider system 102. By way of example, the user enters a search query 510 via a search bar 512 and submits the search query 510, thereby sending the search query 510 over the network 106 to the service provider system 102. In response, the service provider system 102 communicates search results 514 back to the client device 104, thereby causing the client device 104 to display the search results 514 in the user interface 500, e.g., via the display device 116. Here, the search results include item listings 516, 518 of items that correspond to the search query 510. As shown, each of the item listings 516, 518 include one or more images of the listed item, an item category 132 of the listed item, and a user interface element 520, 522 that is selectable to trigger a visual search for items that are visually similar to the listed item.

In FIG. 5b, the user provides a first user input 524 via the user interface 502 selecting the user interface element 520 of the item listing 516. In response, the client device 104 communicates an indication of the first user input 524 to the service provider system 102 as a visual search request 118 to search for items that are visually similar to the seed item 120 of the item listing 516. The service provider system 102 receives the visual search request 118, and outputs updated search results 526 including items/item listings that are visually similar to the seed item 120. In addition, the visual search pivot system 112 generates one or more pivots 122 that are relevant to the seed item 120 in accordance with the described techniques. As shown, the updated search results 526 and the one or more pivots 122 are communicated to the client device 104.

In FIG. 5c, the client device 104 displays the updated search results 526 and the pivots 122 in the user interface 504 of the display device 116. As shown, the updated search results 526 include different item listings 528, 530 that are visually similar to the seed item 120, e.g., sleeveless, medium length dresses. Furthermore, the pivots 122 are visual attributes, which when selected, further refine the visual search, e.g., black, strapless, short. Here, the user provides a second user input 532 selecting one of the pivots 122 displayed in the user interface 504. In response, the client device 104 communicates an indication of the selected pivot 534 to the service provider system 102, e.g., the selected pivot 534 is strapless. The service provider system 102 receives the indication of the selected pivot 534, and generates further updated search results 536 including items/item listings that are visually similar to the seed item 120, and have a visual attribute corresponding to the selected pivot 534.

In FIG. 5d, the client device 104 displays the further updated search results 536 in the user interface 506, e.g., of the display device 116. As shown, the further updated search results include item listings 540, 542 representing items that are visually similar to the seed item 120, and have the visual attribute corresponding to the selected pivot 534, e.g., strapless.

### Example Procedures

The following discussion describes techniques that are configured to be implemented utilizing the previously described systems and devices. Aspects of each of the procedures are configured for implementation in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-5d.

FIG. 6 is a flow diagram depicting a procedure 600 in an example implementation of visual search pivot generation. At block 602, a visual search request is received from a client device to trigger a visual search for items that are visually similar to a seed item. For example, the user provides the first user input 524 to a user interface 114 of the client device 104. In particular, the first user input 524 is provided with respect to a user interface element 520 of an item listing that is selectable to trigger a visual search for items that are visually similar to a seed item 120 represented by the item listing. Therefore, the service provider system 102 receives, as an indication of the first user input 524, a visual search request 118 to display items/item listings that are visually similar to the seed item 120.

At block 604, one or more pivots are generated using a machine learning model based on information associated with the seed item, and the one or more pivots represent visual attribute values for refining the visual search. By way of example, the visual search pivot system 112 receives the visual search request 118, and employs one or more machine learning models 130 as part of a process for generating one or more pivots 122 that are relevant to the seed item 120. The pivots 122 represent or correspond to visual attribute values for refining the visual search. In various implementations, information associated with the seed item 120 (e.g., an image of the seed item 120 obtained from the item listing, an item title of the seed item 120 obtained from the item listing, and an item category 132 of the seed item 120) and user session data 138 are provided as conditioning signals to the machine learning model 130. The pivots 122 are generatable in a variety of ways, as further discussed above with reference to FIGS. 2-4.

At block 606, the one or more pivots are communicated to the client for display in a user interface. For instance, the service provider system 102 communicates updated search results 526 including items/item listings that are visually similar to the seed item 120 along with the generated pivots 122. This causes the client device 104 to display the updated search results 526 and the generated pivots 122 in the user interface 114.

At block 608, a user selection of a pivot is received from the client device. By way of example, the user provides the second user input 532 to the user interface 114 of the client device 104 selecting a pivot 122 (e.g., the selected pivot 534), and the service provider system 102 receives the selected pivot 534 as an indication of the second user input 532.

At block 610, at least one item is communicated to the client device for display in the user interface in response to the user selection, and the at least one item is visually similar to the seed item and has a visual attribute value corresponding to the pivot. In response to receiving the selected pivot 534, for instance, the service provider system 102 communicates further updated search results 536 to the client device 104 including items/item listings that are visually similar to the seed item 120 and which have a visual characteristic corresponding to the selected pivot 122. This causes the client device to display the further updated search results 536 in the user interface 114.

FIG. 7 is a flow diagram depicting a procedure 700 in an example implementation of visual search pivot generation. At block 702, an indication of an item category and a list of attribute categories associated with the item category are provided to a machine learning model. For example, the machine learning model 130 receives an item category 132 of the taxonomy 128, and a list of attribute categories 202 corresponding to the item category 132 in the taxonomy 128. In one or more implementations, the machine learning model 130 additionally receives a prompt requesting the machine learning model 130 to filter out non-visual attribute categories from the attribute categories 202.

At block 704, one or more pivots representing visual attribute values for refining visual searches for items within the item category are generated using the machine learning model, in part, by filtering out non-visual attribute categories from the list. Based on the prompt, for instance, the machine learning model 130 filters out non-visual attribute categories from the list of attribute categories 202, resulting in a filtered list 204 of visual attribute categories 206 associated with the item category 132. Furthermore, the pivot determination module 208 receives the filtered list 204 and user interaction data 126 including common attribute values 210 within a plurality of attribute categories 202. Here, a pivot determination module 208 extracts, as the one or more pivots 122 associated with the item category 132, the common attribute values 210 of the visual attribute categories 206 of the filtered list 204. In one or more implementations, the pivot determination module 208 pairs the item category 132 with the one or more pivots 122 in the cache 134.

At block 706, a visual search request is received from a client device to trigger a visual search for items that are visually similar to a seed item within the item category. For example, the user provides the first user input 524 to a user interface 114 of the client device 104. In particular, the first user input 524 is provided with respect to a user interface element 520 of an item listing that is selectable to trigger a visual search for items that are visually similar to a seed item 120 represented by the item listing that is within the item category 132. Therefore, the service provider system 102 receives, as an indication of the first user input 524, a visual search request 118 to display items/item listings that are visually similar to the seed item 120.

At block 708, the one or more pivots are communicated to the client device for display in a user interface. For example, the pivot retrieval module 212 receives the visual search request 118, including an indication of the item category 132 of the seed item 120. Further, the pivot retrieval module 212 queries the cache 134 with the item category 132, and the cache 134 returns the pivots 122 paired with the item category 132. The visual search pivot system 112 communicates the pivots 122 to the client device 104 to be displayed in the user interface 114.

At block 710, a user selection of a pivot is received from the client device. For instance, the user provides the second user input 532 to the user interface 114 of the client device 104 selecting a pivot 122 (e.g., the selected pivot 534), and the service provider system 102 receives the selected pivot 534 as an indication of the second user input 532.

At block 712, at least one item is communicated to the client device for display in the user interface in response to the user selection, and the at least one item is visually similar to the seed item and has a visual attribute value corresponding to the pivot. In response to receiving the selected pivot 534, the service provider system 102 communicates further updated search results 536 to the client device 104 including items/item listings that are visually similar to the seed item 120 and which have a visual characteristic corresponding to the selected pivot 122. This causes the client device 104 to display the further updated search results 536 in the user interface 114.

### Example System and Device

FIG. 8 illustrates an example system 800 that includes an example computing device 802 that is representative of one or more computing systems and/or devices that implement the various techniques described herein. This is illustrated through inclusion of the visual search pivot system 112. The computing device 802 is configurable, for example, as a server of a service provider (e.g., the service provider system 102), a device associated with a client (e.g., a client device 104), an on-chip system, and/or any other suitable computing device or computing system.

The example computing device 802 as illustrated includes a processing device 804, one or more computer-readable media 806, and one or more input/output (I/O) interfaces 808 that are communicatively coupled, one to another. Although not shown, the computing device 802 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 804 is representative of functionality to perform one or more operations using hardware. Accordingly, the processing device 804 is illustrated as including hardware element 810 that is configurable as processors, functional blocks, and so forth. This includes implementation in hardware as an application specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically executable instructions.

The computer-readable storage media 806 is illustrated as including memory/storage 812 that stores instructions that are executable to cause the processing device 804 to perform operations. The memory/storage 812 represents memory/storage capacity associated with one or more computer-readable media. The memory/storage 812 includes volatile media (such as random access memory (RAM)) and/or nonvolatile media (such as read only memory (ROM), Flash memory, optical disks, magnetic disks, and so forth). The memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” “component,” “system,” and “platform” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing device 804. The instructions and/or functions are executable/operable by one or more articles of manufacture (for example, one or more computing devices 802 and/or processing devices 804) to implement techniques, modules, and examples described herein.

The techniques described herein are supported by various configurations of the computing device 802 and are not limited to the specific examples of the techniques described herein. This functionality is also implementable all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that can be utilized while computer processing is executed on servers that are remote from the computing device 802. Resources 818 can also include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, from a client device, a visual search request to trigger a visual search for items that are visually similar to a seed item;
generating, using a machine learning model, one or more pivots based on information associated with the seed item, the one or more pivots corresponding to one or more visual attribute values for refining the visual search;
communicating, to the client device for display in a user interface, the one or more pivots;
receiving, from the client device, a user selection of a pivot of the one or more pivots; and
communicating, to the client device for display in the user interface and in response to the user selection, at least one item that is visually similar to the seed item and has a visual attribute value corresponding to the pivot.

2. The method of claim 1, wherein the information associated with the seed item includes at least one of a title of the seed item, an image of the seed item, and an item category to which the seed item belongs.

3. The method of claim 1, wherein generating the one or more pivots further comprises:
providing, to the machine learning model, an item category to which the seed item belongs and a list of attribute categories associated with the item category; and
generating, by the machine learning model, a filtered list of visual attribute categories associated with the item category by filtering out non-visual attribute categories from the list.

4. The method of claim 3, wherein generating the filtered list further comprises:
generating, using the machine learning model, a first filtered list by filtering out the non-visual attribute categories from the list; and
generating, using the machine learning model, a second filtered list by filtering out the non-visual attribute categories from the first filtered list, the second filtered list corresponding to the filtered list.

5. The method of claim 3, wherein generating the one or more pivots further comprises:
receiving user interaction data indicating common attribute values associated with each of a plurality of attribute categories; and
extracting, as the one or more pivots for the item category, the common attribute values associated with the visual attribute categories of the filtered list.

6. The method of claim 5, wherein generating the one or more pivots further comprises:
pairing the item category with the one or more pivots in a cache;
querying the cache with the item category of the seed item; and
receiving, from the cache, the one or more pivots of the item category.

7. The method of claim 1, further comprising training the machine learning model to generate the one or more pivots that are relevant to the seed item by:
receiving training data including a first image of a training seed item, a second image of a training target item, and a first textual description of a first visual transition from the training seed item to the training target item;
generating, by the machine learning model and based on the first image of the training seed item, a generated image of a predicted item and a second textual description of a second visual transition from the training seed item to the predicted item; and
updating the machine learning model based on a first comparison of the second image to the generated image, and a second comparison of the first textual description to the second textual description.

8. The method of claim 7, wherein receiving the training data further comprises generating, using an additional machine learning model, the first visual transition from the training seed item to the training target item based on the first image and the second image.

9. The method of claim 7, wherein generating the one or more pivots further comprises:
providing, as input to the machine learning model, a third image of the seed item;
generating, by the machine learning model, a target image of a target item and a third textual description of a third visual transition from the seed item to the target item; and
extracting the one or more pivots from the third textual description.

10. The method of claim 1, further comprising:
collecting user interaction data indicating an additional visual search triggered with respect to a training seed item, the user interaction data including one or more additional items interacted with during the additional visual search and one or more additional visual attribute values of the one or more additional items;
generating one or more predicted pivots based on the training seed item; and
training the machine learning model to generate the one or more pivots that are relevant to the seed item by comparing the one or more additional visual attribute values and the one or more predicted pivots.

11. A system comprising:
at least one processor; and
a memory storing instructions, which when executed by the at least one processor, cause the at least one processor to perform operations including:
providing, to a machine learning model, an indication of an item category and a list of attribute categories associated with the item category;
generating, using the machine learning model, one or more pivots corresponding to one or more visual attribute values for refining visual searches for items within the item category, in part, by filtering out non-visual attribute categories from the list;
receiving, from a client device, a visual search request to trigger a visual search for items that are visually similar to a seed item within the item category;
communicating, to the client device for display in a user interface, the one or more pivots;
receiving, from the client device, a user selection of a pivot of the one or more pivots; and
communicating, to the client device for display in the user interface and in response to the user selection, at least one item that is visually similar to the seed item and has a visual attribute value corresponding to the pivot.

12. The system of claim 11, wherein generating the one or more pivots further includes:
generating, using the machine learning model, a first filtered list of visual attribute categories by filtering out the non-visual attribute categories from the list; and
generating, using the machine learning model, a second filtered list of visual attribute categories by filtering out the non-visual attribute categories from the first filtered list.

13. The system of claim 12, wherein generating the one or more pivots further includes:
receiving user interaction data indicating common attribute values associated with each of a plurality of attribute categories; and
extracting, as the one or more pivots for the item category, the common attribute values associated with the visual attribute categories of the filtered list.

14. The system of claim 11, wherein communicating the one or more pivots further includes:
pairing the item category with the one or more pivots in a cache;
querying the cache with the item category of the seed item responsive to the visual search request; and
receiving the one or more pivots of the item category from the cache.

15. One or more non-transitory computer-readable media storing instructions that, responsive to execution by at least one processing device, cause the at least one processing device to perform operations including:
receiving, from a client device, a visual search request to trigger a visual search for items that are visually similar to a seed item;
generating, using a machine learning model, one or more pivots based on at least one of a title of the seed item, an item category of the seed item, and an image of the seed item, the one or more pivots corresponding to one or more visual attribute values for refining the visual search;
communicating, to the client device for display in a user interface of a search platform, the one or more pivots;
receiving, from the client device, a user selection of a pivot of the one or more pivots; and
communicating, to the client device for display in the user interface and in response to the user selection, at least one item that is visually similar to the seed item and has a visual attribute value corresponding to the pivot.

16. The one or more non-transitory computer-readable media of claim 15, wherein generating the one or more pivots is further based on user session data describing one or more of searches previously entered by the user via the search platform, and items previously interacted with by the user via the search platform.

17. The one or more non-transitory computer-readable media of claim 15, the operations further including training the machine learning model to generate the one or more pivots that are relevant to the seed item by:
receiving training data including a first image of a training seed item, a second image of a training target item, and a first textual description of a first visual transition from the training seed item to the training target item;
generating, by the machine learning model and based on the first image of the training seed item, a generated image of a predicted item and a second textual description of a second visual transition from the training seed item to the predicted item; and
updating the machine learning model based on a first comparison of the second image to the generated image, and a second comparison of the first textual description to the second textual description.

18. The one or more non-transitory computer-readable media of claim 17, wherein receiving the training data further includes generating, using an additional machine learning model, the first visual transition from the training seed item to the training target item based on the first image and the second image.

19. The one or more non-transitory computer-readable media of claim 17, wherein generating the one or more pivots further includes:
providing, as input to the machine learning model, the image of the seed item;
generating, by the machine learning model, a target image of a target item and a third textual description of a third visual transition from the seed item to the target item; and
extracting the one or more pivots from the third textual description.

20. The one or more non-transitory computer-readable media of claim 15, the operations further including:
collecting user interaction data indicating an additional visual search triggered with respect to a training seed item, the user interaction data including one or more additional items interacted with during the additional visual search and one or more additional visual attribute values of the one or more additional items;
generating one or more predicted pivots based on the training seed item; and
training the machine learning model to generate the one or more pivots that are relevant to the seed item by comparing the one or more additional visual attribute values to the one or more predicted pivots.
